(19) United States
(12) Patent Application Publication
(10) Pub. No.: US 2011/0162091 A1
(43) Pub. Date: Jun. 30, 2011

(54) METHOD OF DEACTIVATION AFTER SOFTWARE BEING ACTIVATED ONLINE

(76) Inventor: DING HUANG, Guangzhou (CN)

(21) Appl. No.: 12/968,312

(22) Filed: Dec. 15, 2010

(30) Foreign Application Priority Data
Dec. 31, 2009 (CN) 200910214556.X

(51) Int. Cl. G06F 21/22

(52) U.S. Cl. 726/33

(57) ABSTRACT

A method of deactivation after software being activated online is provided, including: online-activated software sending a deactivation request message and its license key to a network server; the request being validated by the server inquiring its file system; if the request being valid, the server changing the status of the license key into “deactivated” or deleting the license key and its associate information in its file system and sending a deactivation permission message to the software; after receiving the deactivation permission message the software deleting or modifying local activation information promptly to ensure the software cannot run in activated status any more. By this method, an activated software user could initiatively deactivate the software on its current hardware device and then activate the software on another hardware device. The method of the invention enables user to transfer the software license to another hardware device initiatively.

### TECHNICAL FIELD

This invention relates to the technical field of transferring software license from one hardware device to another hardware device.

### BACKGROUND OF THE INVENTION

Product online activation is a mainstream option for many companies and individual developers throughout the software industry. Many software use online activation technology to prevent pirating, such as Windows XP typically. Software developers usually forbid a user to activate their software with one license key on more than allowed number of hardware devices; therefore copyright of the software is effectively protected. However, when the software user wants to use other hardware device, he or she will meet the following problem: the user has no way to withdraw the prior activation initiatively; therefore he or she cannot use the license key to activate corresponding software in other hardware device. In this situation the benefit of user is damaged, because we believe the user has the right to transfer the software license to other hardware device.

To change the situation, there needs some technical method to enable a software user to transfer a software license from one hardware device to another on his or her own initiative without infringing the software license.

The purpose of this invention is to overcome the shortcoming of present technology and to provide a method of deactivation after software being activated online, therefore the user can transfer the software license to another hardware device initiatively.

### BRIEF SUMMARY OF THE INVENTION

A method is described that enable a software user to transfer a software license from one hardware device to another on his or her own initiative without infringing the software license. Stated generally, the method comprises setting a deactivation module of the software, setting a server file system to record the activated status and/or deactivated status of license keys of the software on a network server, and setting a deactivation module on the network server which deals with deactivation requests from the software. Suppose a user has activated the software on a hardware device with a license key. When the deactivation module of the software is run by the user initiatively, the deactivation module sends to the network server a deactivation request with sufficient information (license key at least) to identify the software on the hardware device; then the deactivation module on the network server determines the validity of the deactivation request of the software by inquiring the server file system and, if it is valid, changes the status of the software on the hardware device to “deactivated” in the server file system and sends a deactivation permission message to the software ; and then the deactivation module of the software does necessary actions immediately to put the software on the hardware device into a deactivated status, as if the software had never been activated on the hardware device. Then the user can activate the software with the license key on other hardware device.

There should be a corresponding activation process in order to make the deactivation process work properly. During the activation process, the validity of the activation of the software on a hardware device should be determined by the network server, and the activated status of the software on the hardware device if permitted should be recorded in the file system on the network server. The activation process involves communications between the software and the network server, therefore the corresponding activation process is an online process. This invention demands that any software implementing the deactivation method have an activation module which activates the software online on a hardware device, and there be an activation module on the network server which deals with the activation requests of the software.

The exemplary implementations of the method of the invention for various software licenses are illustrated in two embodiments. In the first embodiment, a single license key whose activation is bundled with hardware device information is transferred to another hardware device. In the second embodiment, a time-limited multiple-hardware-device license key whose activation is bundled with hardware device information is transferred to another hardware device.

The advantage of the invention compared with prior art is that the method of invention enables a software user to deactivate the software after the software being activated online, so that the user can transfer the software license to another hardware device initiatively for activating the corresponding software under the allowance number of the license. By so doing, the invention technically gives the right of transferring software license to users; meanwhile the benefit of software developers is not damaged.

### BRIEF DESCRIPTION OF THE DRAWINGS

FIG. 1 is a work flow chart of the method of online deactivation in the invention.

FIG. 2 is a work flow chart of an exemplary online activation process.

FIG. 3 is a diagram of an exemplary operation of the invention.

FIG. 4A is a flow diagram of an embodiment of online deactivation process of software with a single license key in the invention.

FIG. 4B illustrates changes of the database on the server in the process of FIG. 4A.

FIG. 5A is a flow diagram of an exemplary process of online activation of the software with the single license key after the deactivation process of FIG. 4A.

FIG. 5B illustrates changes of the database on the server in the process of FIG. 5A.

FIG. 6 illustrates changes of the database on the server in the processes of deactivation and activation of software with a time-limited multiple-hardware-device license key in an embodiment of the invention.

The same numbers are used throughout the disclosure and figures to reference like components and features.

### DETAILED DESCRIPTION OF THE INVENTION

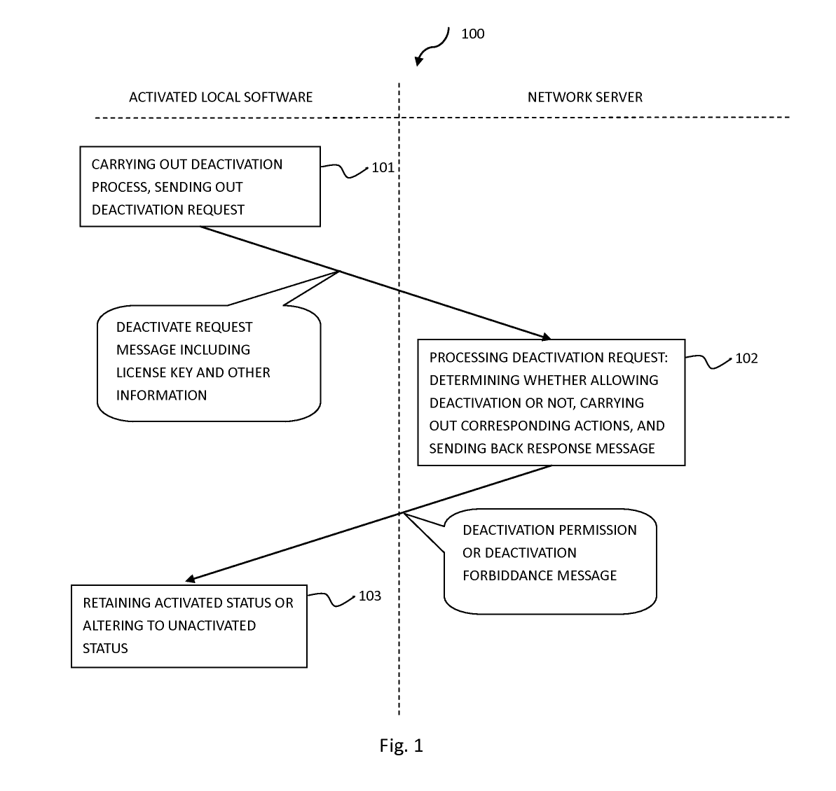

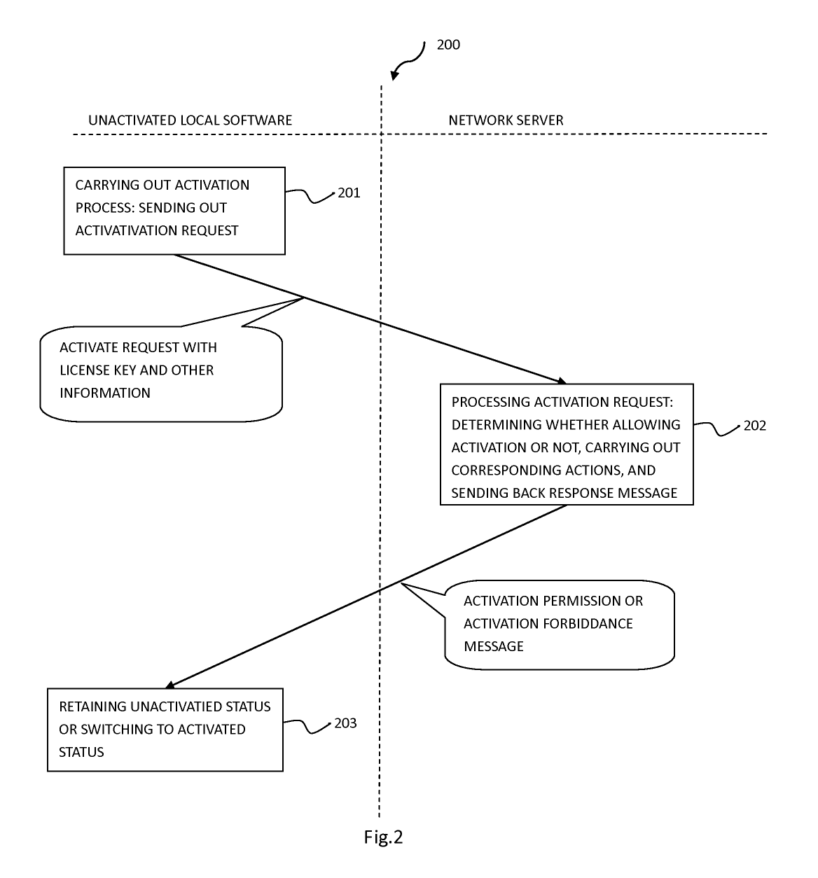

### Overview of the Method—FIG. 1 and FIG. 2

FIG. 1 is a work flow chart illustrating a process 100 of deactivating software after the software is activated online. The deactivation process involves activated local software and a network server separated by dashed lines in FIG. 1, and the communications between them are illustrated as arrows across the dashed lines. The deactivation process is launched at step 101 when the user runs the deactivation function of the software. The local software generates a deactivation request message packaging license key which has been used to activate the software on the current hardware device and other information necessary for the network server to validate the request (e.g., hardware device information bundled with the license key in the activation process of the software). The local software sends out the deactivation request message to the network server and waits for its response. When the network server receives the deactivation request message, it processes the deactivation request and gives response message at step 102. At step 102, the network server firstly validates the deactivation request by inquiring its file system which has recorded all the license keys with associate information bundled in the activation process of the software. If the information associated with the license key in the server file system is identical with that in the deactivation request message, the request is valid, otherwise it is invalid. If the request is valid, the network server modifies the file system to change the status of the license key to “deactivated” or to delete the license key and its associate information and sends a deactivation permission response to the software; otherwise the network server does not modify the file system and sends a deactivation forbiddance response to the software. At step 103, the local software takes actions according to the response. When the software receives the deactivation forbiddance response, it just tells the user of the fact and remains running in activated status. When the software receives the deactivation permission response, the software immediately deletes or modifies local activation information to ensure the software cannot run in activated status any more, until the software is activated on the hardware device again.

FIG. 2 is a work flow chart of activation online process 200 which works together with the deactivation online process illustrated in FIG. 1 to enable the software user to transfer the license key successfully. The activation process involves inactivated local software and a network server separated by dashed lines in FIG. 2, and the communications between them are illustrated as arrows across the dashed lines. The activation process is launched at step 201 by the local software when the user runs the activation function of the software. The local software sends out an activation request message packaging the license key and other information bundled in activation to the network server and waits for its response. When the network server receives the activation request message, it processes the activation request and gives response message at step 202. At step 202, the network server firstly validates the activation request by analyzing the license key in the request and inquiring its file system. The activation request is valid if the license key in the activation request is within the period of validity and the number of activated status of the license key in the server file system does not achieve the allowance number. If the activation request is valid, the network server modifies the file system to remember the status of the license key as “activated” and the bundled information in the request as the associate information of the license key by creating new record or changing existing record, and sends an activation permission response to the software; otherwise the network server does not modify the file system and sends an activation forbiddance response to the software. At step 203, the local software takes actions according to the response. When the software receives the activation forbiddance response, it just tells the user of the fact and remains running in inactivated status. When the software receives the activation permission response, the software immediately does necessary actions (e.g., creating local activation information file) to ensure the software to run in activated status at once or at next launch.

### Exemplary Operating Process

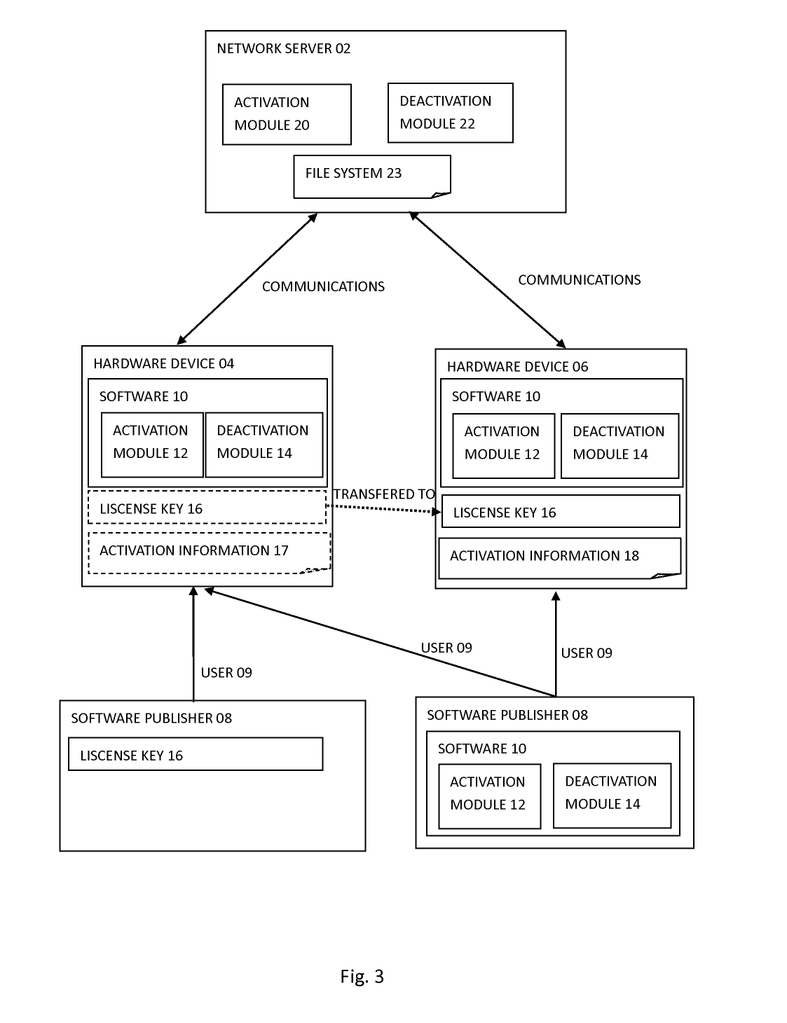

FIG. 3 illustrates one operating process of the invention to assist the reader in understanding where and how the invention works. The exemplary environment in which the invention applies comprises software 10, two hardware devices—hardware device 04 and hardware device 06, and network server 02. Software publisher 08 publishes software 10 containing activation module 12 and deactivation module 14 and license keys of the software. User 09 gets software 10 and license key 16 from the software publisher. The user runs the software on hardware device 04, and activates the software online with license key 16 by running activation module 12 of the software. During the activation online process, activation module 12 interacts with network server 02, and network server 02 remembers in its file system 23 the activated status of the license key 16 on hardware device 04. When the software is activated, there is activation information 17 on hardware device 04 which enables the software to run in activated status. When the user wants or needs to activate the software on hardware device 06, he or she deactivates the software on hardware device 04 at first and then activate the software with license key 16 on hardware device 06. During the deactivation process, deactivation module 14 on hardware device 04 sends deactivation request with necessary information to network server 02. The server validates the request, and if the request is valid, the server modifies the status of the license key on hardware device 04 to “deactivated” in its file system 23 and sends deactivation permission to hardware device 04. The deactivation module 14 on hardware device 04 deletes or modifies activation information 17 on hardware device 04 in response. The software on hardware device 04 can no longer run in activated status. Until now license key 16 can be used to activate the software on other hardware device or hardware device 04 again, as if it had never been used to activate the software on hardware device 04. The user then activates the software on hardware device 06 with license key 16. After an interaction process between the activation module 12 on hardware device 06 and server 02, activation information 18 is created on hardware device 06 which enables the software to run in activated status, and file system 23 of server 02 records the “activated” status of license key 16 on hardware device 06. After the deactivation process on hardware device 04 and activation process on hardware device 06, the license key 16 is transferred from hardware device 04 to hardware device 06 by the user initiatively, which is shown as a dashed-arrow in FIG. 3.

Next in the following two embodiments, the implementation of the invention is described, wherein two processes of deactivation and activation of the software are provided, and the server file system specifically uses a database to store the license key, its status (activated or deactivated), and other associate information. However, the implementation method of the invention is not limited by these specific embodiments.

### Embodiment 1

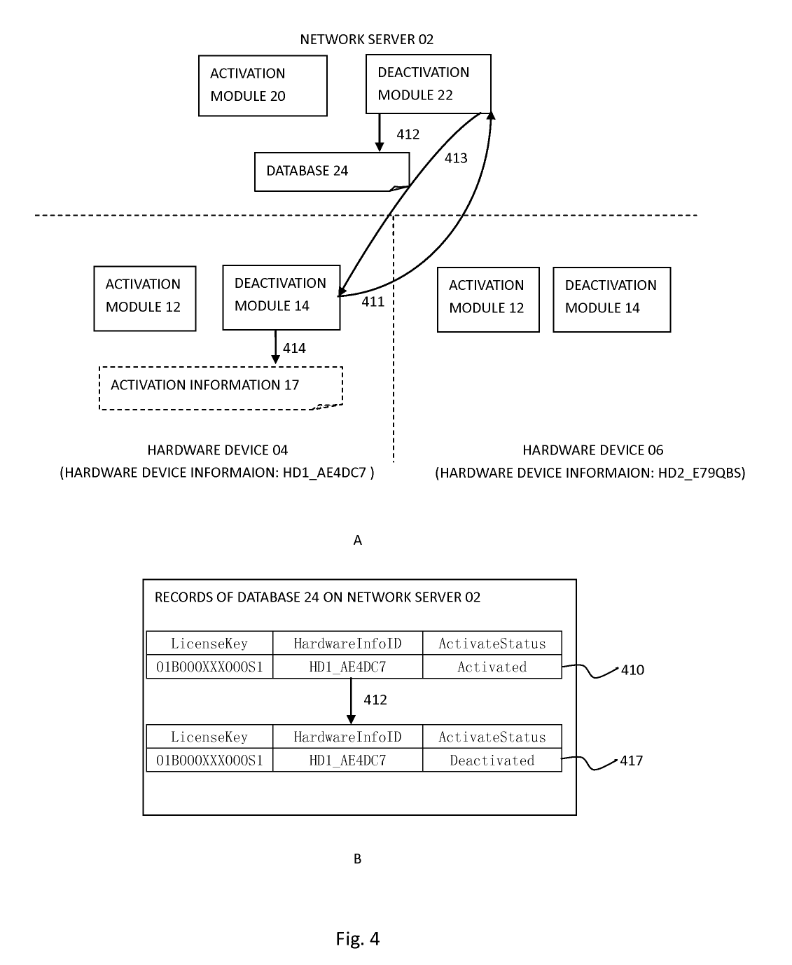

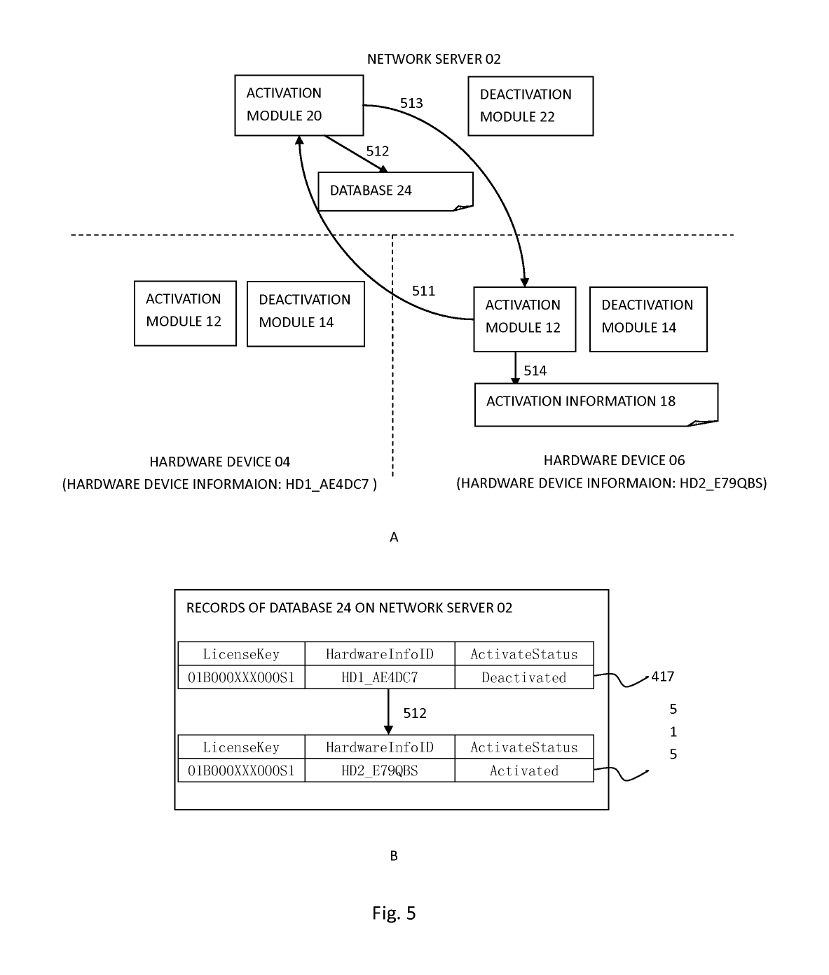

For a single license key, and the activation of the software is bundled with hardware device information, the user can deactivate the activated software on one hardware device and then activate the software on another hardware device. The deactivation process of the software is illustrated in FIG. 4A-4B, and the activation process is illustrated in FIG. 5A-5B.

In FIG. 4A, there are network server 02, hardware device 04 (hardware device information HD1_AE4DC7) and hardware device 06 (hardware device information HD2_E79QBS) separated by dashed lines. Database 24 on server 02 illustrated in FIG. 4B comprises three fields: LicenseKey which records all license keys which have been used to activate or deactivate the software, HardwareInfoID which records all hardware device information bundled with the license keys in field LicenseKey when activating the software, and ActivateStatus which records the activated or deactivated status of the license keys in field LicenseKey on hardware device whose hardware device information is in field HardwareInfoID. A license key “01B000XXX000S1” has been used to activate the software on hardware device 04, resulting in a record 410 in database 24 on server 02. Record 410 can be translated like this: license key “01B000XXX000S1” has been used to activate the software on a hardware device whose hardware device information is HD1_AE4DC7.

At arrow 411 in FIG. 4A, when the user initiatively launches the deactivation process of the software on hardware device 04, deactivation module 14 of the software sends a deactivation request with the license key “01B000XXX000S1” which has been used during activating and the hardware device information of hardware device 04 “HD1_AE4DC7” to the server. The deactivation request message can be translated like this: software on HD1_AE4DC7 asks for deactivation with license key 01B000XXX000S1.

Deactivation module 22 on server 02 processes the deactivation request at arrow 412 and gives response message to the software at arrow 413. At arrow 412, deactivation module 22 validates the deactivation request by inquiring in database 24 the existence of the license key in the request (“01B000XXX000S1”) and the sameness between the hardware device information in the request (HD1_AE4DC7) and that associated to the license key in the database. If the request is validated successfully, also at arrow 412, deactivation module 22 changes the status in the corresponding record (record 410) into “deactivated” (record 417) and sends a deactivation permission message to the software at arrow 413; otherwise database 24 remains unchanged at arrow 412 and deactivation module 22 sends a deactivation forbiddance message to the software at arrow 413.

When deactivation module 14 of the software on hardware device 04 receives the response message from server 02, what it does depends on the response message. If the response message is deactivation forbiddance, it just notifies the user of the fact, and the software on hardware device 04 keeps running in activated status; otherwise it immediately deletes local activation information 17 at arrow 414, thus the software on hardware device 04 is put into inactivated status at once or at next launch.

FIG. 5A illustrates the process that the user activates the software on hardware device 06 with the license key “01B000XXX000S1”, and FIG. 5B illustrates the changing of database 24 during the process.

At arrow 511, when the user launches the activation process of the software on hardware device 06, activation module 12 on hardware device 06 sends an activation request with the license key “01B000XXX000S1” and the hardware device information of hardware device 06 “HD2_E79QBS” to server 02. The activation request message can be translated like this: software on HD2_E79QBS asks for activation with license key 01B000XXX000S1.

Activation module 20 on server 02 processes the activation request at arrow 512 and gives response message to the software at arrow 513. At arrow 512, activation module 20 validates the activation request by inquiring in database 24 the license key “01B000XXX000S1” and if any record is found, verifying the status in the record being “deactivated”. The activation request is valid too if there is no license key “01B000XXX000S1” in the database, which means the license key is being used to activate the software for the first time. If the activation request is validated successfully, activation module 20 modifies database 24 also at arrow 512 by changing the status in the corresponding record (record 417) into “activated” and replacing the hardware device information in the record with the hardware device information “HD2_E79QBS” (record 515), or adding record 515 as a new record if no record of the license key “01B000XXX000S1” is found in the database, and sends an activation permission message to the software at arrow 513; otherwise the database remains unchanged at arrow 512 and activation module 20 sends an activation forbiddance message to the software at arrow 513.

When activation module 12 of the software on hardware device 06 receives the response message from the server, what it does depends on the response message. If the response message is activation forbiddance, it just notifies the user of the fact, and the software on hardware device 06 keeps running in inactivated status; otherwise it immediately creates local activation information 18 at arrow 514, thus the software on hardware device 06 is put into activated status at once or at next launch.

### Embodiment 2

For a time-limited multiple-hardware-device license key, and the activation of the software is bundled with hardware device information, the user can activate the software with the license key on no more than allowed number of hardware devices and use the activated software on those hardware devices for no more than the time permitted since the first activation of the software. Within the time period, the user can deactivate any one of those activated software on its current hardware device and then activate the software on another hardware device with the license key.

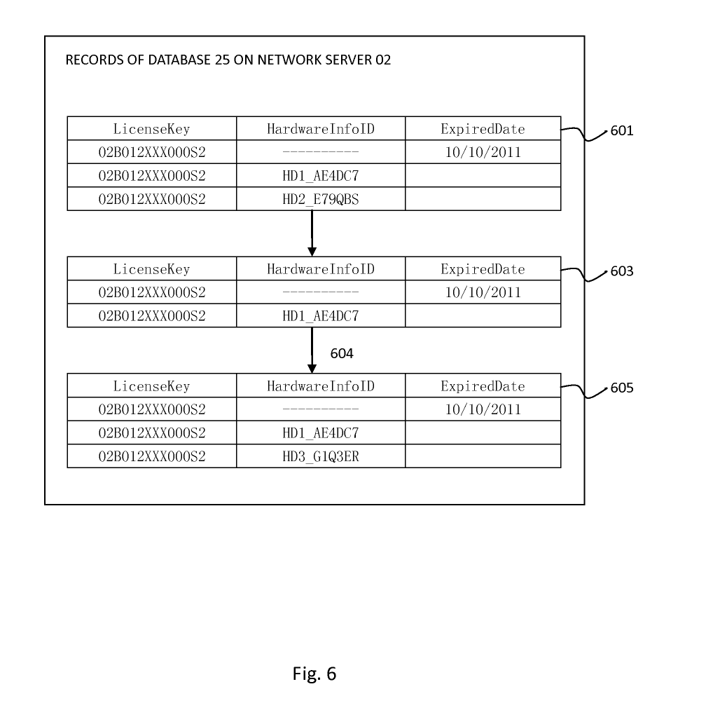

In this embodiment, network server 02 uses database 25 to store license keys and associate information. The changing of database 25 on server 02 during the deactivation and activation processes is illustrated in FIG. 6.

Database 25 on sever 02 includes three fields: LicenseKey which records all license keys which have been used to activate the software, HardwareInfoID which records all hardware device information bundled with the license keys in field LicenseKey, and ExpiredDate which records expired dates of the license keys.

Suppose the allowance number of the multiple-hardware-device license key “02B012XXX000S2” is two, the time-limitation of it is one year, the user has used the license key to activate the software on two hardware devices whose hardware device information is “HD1_AE4DC7” and “HD2_E79QBS” respectively, and the first activation happens on Oct. 10, 2010, then the content of database 25 on server 02 is table 601 in FIG. 6. There are three records of license key “02B012XXX000S2” in table 601. The first record remembers the expired date of the license key “02B012XXX000S2”. It is added to the database when the license key is used for the first time to activate the software on hardware device “HD1_AE4DC7” on the date Oct. 10, 2010. During the first activation process, the activation module on the server calculates the expired date of the license key as one year after Oct. 10, 2010, which is Oct. 10, 2011, and adds the first record into database 25. The second and third records remembers the activated status of the license key “02B012XXX000S2” on hardware device “HD1_AE4DC7” and hardware device “HD2_E79QBS”.

Now the user wants to transfer the license key “02B012XXX000S2” from hardware device “HD2_E79QBS” to a third hardware device “HD3_G1Q3ER”. The user accomplishes this task by firstly deactivating the software with the license key on hardware device “HD2_E79QBS” and secondly activating the software with the license key on hardware device “HD3_G1Q3ER”.

The deactivation process of the software on hardware device “HD2_E79QBS” is quite like the deactivation process in embodiment 1. When the deactivation module on the server has validated successfully the deactivation request, at arrow 602, it simply deletes the record which remembered the activated status of the license key “02B012XXX000S2” on hardware device “HD2_E79QBS”, which resulting in table 603, then sends a deactivation permission response message to the software.

The activation process of the software on hardware device “HD3_G1Q3ER” is basically the same as the activation process in embodiment 1. When the activation module on the server has validated successfully the activation request, at arrow 604, it adds into the database a record which remembers the activated status of the license key “02B012XXX000S2” on hardware device “HD3_G1Q3ER”, which resulting in table 605, then sends a deactivation permission response message to the software.

### CONCLUSION

The foregoing detailed description illustrates that exemplary embodiments of the invention provide a method of software deactivation after the software being activated online. By these embodiments, a software user can deactivate the software after activating the software online and then activate the software on another hardware device with the same license key. Thus the user can initiatively transfer the software license to another hardware device without infringing the software license.

Although the embodiments above are exemplary implements of the method of the invention, it is to be understood that the invention defined in the appended claims is not necessarily limited to the specific features or steps described, and any change, modification, replacement, combination and simplification that do not deviate the spirit and principle of the invention should be regard as equivalent replacement and be included in the protection scope of the invention.

The invention claimed is:

1. In a system interconnecting a local software including a deactivation module and a network server including a server file system recording activation information of the software, a method of software deactivation after it being activated online comprising:
deactivation module of the software sending a deactivation request message to the network server;
the network server validating the request in response to receiving the deactivation request message, and if the validation being successful, modifying or deleting corresponding records in server file system and sending a deactivation permission message to the software;
the deactivation module of the software deleting or modifying local activation information in response to receiving the deactivation permission message.

2. The method of claim 1, wherein the deactivation request message comprises a license key and other information if needed; and the other information comprises hardware device information if the activation of the software is bundled with hardware device information.

3. The method of claim 1, wherein after the software receives the deactivation permission message, the deactivation module of the software deletes or modifies local activation information, and the software switches to inactivated status at once or at next launch; otherwise the software remains in activated status.
